(19) United States
(12) Patent Application Publication
(10) Pub. No.: US 2026/0097307 A1
(43) Pub. Date: Apr. 9, 2026

(54) GAME MOVE TRAINING SYSTEM

(71) Applicant: QANBA USA, LLC, Daly City, CA (US)

(72) Inventors: Jeffrey Lyo, Daly City, CA (US); Kai Liu, Shenzhen (CN); Xiang Long Zhong, Shenzhen (CN)

(21) Appl. No.: 19/258,826

(22) Filed: Jul. 2, 2025

(30) Foreign Application Priority Data
Jul. 3, 2024 (CN) 202410882711X

(51) Int. Cl. A63F 13/5375

(52) U.S. Cl. CPC A63F 13/5375

(57) ABSTRACT

The present disclosure discloses a system for training a game move. The system may include a gaming controller, a display, and a host, where the gaming controller may include a control panel, a plurality of switches arranged on the control panel, and a plurality of indicators corresponding to the plurality of switches. The gaming controller and the display may be connected to the host respectively. The gaming controller may be configured to receive a game move instruction from the host to control a first indicator and a first switch corresponding to the first indicator. The display may be configured to display a game move image based on the game move instruction from the host, and the gaming controller may further be configured to perform the game move training based on the first indicator and the game move image.

### CROSS-REFERENCE TO RELATED APPLICATION(S)

The present application claims priority to and the benefit of Chinese Patent Application No. 202410882711X, filed at the China National Intellectual Property Administration on Jul. 3, 2024, the entire disclosure of which is incorporated herein by reference.

### TECHNICAL FIELD

The present disclosure relates to the field of game peripherals, and for example, a game move training system.

### BACKGROUND

Existing game move trainings are performed by displaying on a display screen of a personal computer (PC). For example, a game may require a player to press a specific sequence of buttons or keys (with corresponding timings) to control a game character to perform a corresponding action (e.g., a “special move” triggered by pressing a specific button sequence and/or combination, sometimes referred to as a “combo”). Some software for training players on executing these combos involves displaying a corresponding virtual game buttons (e.g., up, down, left, right, punch, kick, and/or the like) on the display screen, where the displayed virtual game buttons are lit up accordingly. Because the lit game switches are displayed on the display screen, a user may only perform an imaginary game move training by watching the display screen. The user's experience may be compromised. Therefore, it is not conducive to the game move training.

### SUMMARY

An object of the present disclosure is to provide a system for training game moves (or game combos) based on switches of a gaming controller to enhance a user experience when a player is learning to execute the game moves.

The present disclosure achieves the above-mentioned object with the following technical solutions:

A first aspect of the present disclosure provides a system for training a game move. The system may include a gaming controller, a display, and a host, where the system is a system for assisting a game move training with a game move image shown on the display, and where the gaming controller may include a control panel, a plurality of switches arranged on the control panel, and a plurality of indicators corresponding to the plurality of switches; the gaming controller and the display may be respectively connected to the host; the gaming controller may be configured to receive a game move instruction from the host to control a first indicator and a first switch corresponding to the first indicator; the display may be configured to display a game move image based on the game move instruction from the host; and the gaming controller may be configured to perform the game move training based on the first indicator and the game move image.

In one or more embodiments, the host may include a memory, and the memory is configured to store the game move instruction.

In one or more embodiments, the first indicator may include an indicator light, and the indicator light indicates the first switch by a light of a predetermined color.

In one or more embodiments, the indicator light may be arranged under the first switch or between the control panel and the first switch.

In one or more embodiments, the first indicator may include a haptic feedback device, and the haptic feedback device may indicate the switch by vibration.

In one or more embodiments, the system may further include an input-and-output bus, the input-and-output bus may be configured to receive the game move instruction from the host; output the game move instruction to the gaming controller; and output a game operation instruction to the host.

In one or more embodiments, the gaming controller may include a processing circuit, and the processing circuit may be configured to receive the game move instruction and convert the game move instruction into a light control instruction for the indicator light.

In one or more embodiments, the gaming controller may include a processing circuit, and the processing circuit may be configured to receive the game move instruction and convert the game move instruction into a vibration instruction for the haptic feedback device.

In one or more embodiments, the game move instruction may include a data frame in a preset size.

In one or more embodiments, a mapping may be established between the game move instruction and a move sequence of the gaming controller.

In one or more embodiments, the mapping may include at least one of: an action of the game move image corresponding to the first switch, a plurality of actions of the game move image corresponding to the first switch, an action of the game move image corresponding to the plurality of switches, and a plurality of actions of the game move image corresponding to the plurality of switches.

A second aspect of the present disclosure provides a method for training a game move. The method may include receiving, from a host at a gaming controller, a game move instruction, where the gaming controller includes a control panel, a plurality of switches arranged on the control panel, and a plurality of indicators corresponding to the plurality of switches, and the game move instruction may be configured to control a first indicator and a first switch corresponding to the first indicator; displaying, at a display, a game move image based on the game move instruction from the host, wherein the display is connected to the host; and training, by the gaming controller, the game move based on the first indicator and game move image.

In the present disclosure, the game move training may be performed according to the game move instruction of the indicator and the game move image. In this case, the present disclosure may enable a user to practice their game moves according to the game move instruction of the indicator on the gaming controller. For example, a user may press the corresponding switch according to the game move instruction of the indicator on the gaming controller. In this way, the user's gaming level may be improved by simulating a regular gaming operation in real time.

### BRIEF DESCRIPTION OF THE DRAWINGS

To more clearly illustrate the technical solutions in one or more embodiments of the present disclosure or in the existing technology, the following will briefly introduce the drawings needed for the description of the one or more embodiments or the existing technology. The drawings described below are only some embodiments of the present disclosure. For a person of ordinary skill in the art, other drawings may be obtained based on these drawings without creative efforts.

FIG. 1 is a schematic diagram of an example game move training system, according to one or more embodiments of the present disclosure.

FIG. 2 is a structural diagram of an example gaming controller, according to one or more embodiments of the present disclosure.

1. gaming controller; 2. display; 3. host; 4. Input-and-output bus; 10. switch area; 11. switch; 12. control panel; 20. function area; 30. support area.

### DETAILED DESCRIPTION

In order to make the objects, technical solutions and advantages of the present disclosure clear, the technical solutions of the present disclosure will be described in detail below. The embodiments described herein are only part of the embodiments of the present disclosure, not all of them. Based on these embodiments of the present disclosure, all other embodiments or implementations obtained by a person of ordinary skill in the art without creative efforts should fall within the scope of protection of the present disclosure.

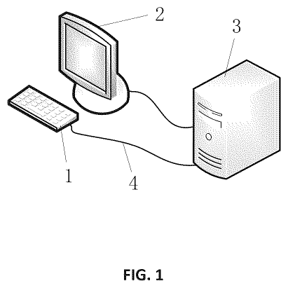

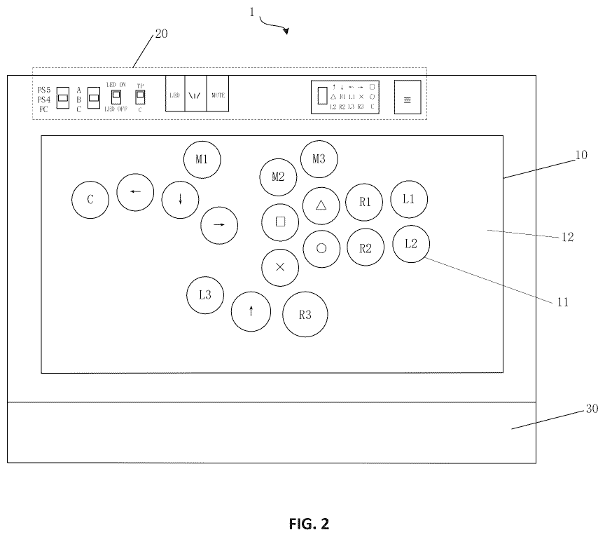

FIG. 1 is a schematic diagram of an example game move training system, according to one or more embodiments of the present disclosure. FIG. 2 is a structural diagram of an example gaming controller, according to one or more embodiments of the present disclosure.

Referring to FIG. 1, the present disclosure provides the game move training system (hereinafter sometimes referred to as the system), which is a system for assisting a game move training with game move images on a display. The system may include a gaming controller 1, a display 2, and a host 3. In various embodiments of the present disclosure, the host 3 may be implemented by a computer system including a processor and memory, such as a desktop computer, a laptop computer, a game console, and the like.

In some embodiments, the gaming controller 1 may include a control panel 12, a plurality of switches 11 arranged on the control panel, and a plurality of indicators corresponding to a switch. For example, each of the plurality of indicators may be arranged to have a corresponding switch.

In some embodiments, the gaming controller 1 and the display 2 may be connected to the host 3 respectively. In some embodiments, the display 2 may receive a game move image, corresponding to a game move instruction, output by the host 3 (e.g., receive the game move image from the host 3) to display the game move image. In some embodiments, the gaming controller 1 may receive a game move instruction output by the host 3 to control the indicator to indicate its corresponding switch 11. In some embodiments, the game move training may be performed according to the game move instruction (e.g., an indication to control the indicator) and/or the game move image.

In the present disclosure, the game move training may be performed based on the game move instruction of the indicator and the game move image. In this case, a user may perform the game move training (e.g., be trained to execute the game move, such as by pressing a sequence of buttons with the required timings) based on the game move instruction of the indicator on the gaming controller 1. For example, a user may click/press the corresponding switch 11 on the gaming controller 1 according to the game move instruction of the indicator. Thus, the user's gaming competitive level may be improved by simulating the regular gaming operation in real time.

In some embodiments, the host 3 may include a memory. The memory may be used to store game instructions (e.g., the game move instruction).

In some embodiments, the indicator may include an indicator light. The indicator light may indicate a switch 11 (e.g., the indicator's corresponding switch) by means of light of a predetermined/preset color. For example, the indicator light may be a red light to indicate a corresponding switch of the indicator.

In some embodiments, the predetermined color may be red, blue, and/or the like. In some embodiments, the predetermined color may also be other colors that are easily recognizable by the user.

In some embodiments, the indicator light may be arranged below the switch 11. In some embodiments, the indicator light may be arranged between the control panel 12 and the switch 11. For example, there may be a gap between the control panel 12 and the switch 11, and the indicator light may be configured to emit its light outward through the gap.

In some embodiments, the indicator light may be a light strip arranged around the switch 11.

In some embodiments, the indicator may include a haptic feedback device. The haptic feedback device may indicate the switch 11 by vibration. For example, the haptic feedback device may be a device that includes a vibrator motor and may reflect an instruction to a corresponding switch via vibration. In some embodiments, the haptic feedback device may be arranged under the switch 11.

In some embodiments, the system may further include an input-and-output bus 4 (or I/O bus). The input-and-output bus 4 may be used to transmit the game move instruction output by the host 3 to the gaming controller 1. Furthermore, the input-and-output bus 4 may also be used to transmit a game operation instruction from the gaming controller 1 to the host 3. In some embodiments, the game operation instruction may be an instruction for controlling a game character to move.

In some embodiments, the gaming controller 1 may include a processing circuit. The processing circuit may be used to receive the game move instruction and convert the game move instruction into a light control instruction of an indicator light or a vibration instruction of a haptic feedback device.

In some embodiments, the game move instruction may include a data frame in a preset size. In some embodiments, the preset size of the data frame may correspond to a video frame of a game move image. For example, the transmission speed of the data frame may correspond to both of the display speed of the game move image(s) and the user's operating speed during a training session. Therefore, the transmission speed of the data frame may not be too fast nor too slow. For example, a size of the data frame in the game move instruction may be associated with a corresponding image frame of the game move image. Furthermore, a polling rate of the gaming controller 1 may correspond to a frame rate of the display 2 to enhance the data/instruction transmission, thereby improving the user's gaming experience.

In some embodiments, a mapping may be established between the game move instruction and a move sequence of the gaming controller 1.

In some embodiments, the mapping may include at least one of: an action of the game move image corresponding to a switch, a plurality of actions of the game move image corresponding to a plurality of switches, an action of the game move image corresponding to the plurality of switches, and/or a plurality of actions of the game move image corresponding to the plurality of switches.

Referring to FIG. 2, in some embodiments, the gaming controller 1 may include a switch area 10 and a function area 20.

In some embodiments, the switch area 10 may include a control panel 12 and a plurality of switches 11 arranged on the control panel 12.

In some embodiments, the gaming controller 1 may further include a support area 30. The support area 30 may be used to support the hand(s) or wrist(s) of a user (e.g., a game player), thereby facilitating the user's operation and rest.

In the present disclosure, the game move instruction output by the host 3 may be sent to one switch 11 or a plurality of switches 11 based on the above mapping. For example, the “←” switch in FIG. 2 is a switch for controlling the game character to move to the left. If (e.g., when) the game move instruction is to control the “←” switch to be lighted up, such game move instruction may control the game character to move to the left. At this time, the user may click/press the “←” switch according to the game move instruction (e.g., an indication to light up the indicator light next to the “←” switch).

In some embodiments, the “R1” switch in FIG. 2 may be a switch for controlling an action of a game character (e.g., a jump function of the game character). For example, if (e.g., when) the game move instruction is to control the “+” switch and the “R1” switch to light up, such game move instruction may control the game character to jump to the left. At this time, the user may click/press the “←” switch and the “R1” switch at the same time according to the game move instruction (e.g., an indication to light up indicator lights corresponding to the “←” switch and the “R1” switch that are next to the “←” switch and the “R1” switch respectively). At the same time, the game move image) is displayed synchronously (e.g., the game move image is displayed as the user presses the switches) on the display 2. The user may perform the game move training by a combination of operating the switch 11 according to the game move instruction and viewing the display 2.

The present disclosure may also provide a method for training a game move based on switches 11 on the gaming controller 1. The method includes performing a game move training according to the switch 11 indicated by the above-mentioned game move training system.

The benefits of the present disclosure may include enabling the user to perform the game move training according to the indication (e.g., indicator light or vibration) of the indicator on the gaming controller 1. Therefore, the user's gaming level and the user experience may be improved by simulating a regular, more intuitive gaming operation in real time.

The above are merely some specific embodiments of the present disclosure, but the scope of protection of the present disclosure and equivalents thereof are not limited thereto. A person skilled in the art can easily think of changes or substitutions within the technical scope disclosed in the present disclosure, which should be covered within the scope of protection of the present disclosure and equivalent thereof. Therefore, the scope of protection of the present disclosure and equivalent thereof shall be determined by the scope of protection of the claims and equivalents thereof.

What is claimed is:

1. A system for training a game move, comprising:
a gaming controller;
a display; and
a host, wherein the system is a system for assisting a game move training with a game move image shown on the display, and wherein:
the game controller comprises a control panel, a plurality of switches arranged on the control panel, and a plurality of indicators corresponding to the plurality of switches;
the game controller and the display are connected to the host respectively;
the gaming controller is configured to receive a game move instruction from the host to control a first indicator and a first switch corresponding to the first indicator;
the display is configured to display the game move image based on the game move instruction from the host; and
the gaming controller is further configured to perform the game move training based on the first indicator and the game move image.

2. The system of claim 1, wherein the host comprises a memory, and the memory is configured to store the game move instruction.

3. The system of claim 1, wherein the first indicator comprises an indicator light, and the indicator light indicates the first switch by a light of a predetermined color.

4. The system of claim 3, wherein the indicator light is arranged under the first switch or between the control panel and the first switch.

5. The system of claim 1, wherein the first indicator comprises a haptic feedback device, and the haptic feedback device indicates the first switch by vibration.

6. The system of claim 1, further comprising an input-and-output bus, wherein the input-and-output bus is configured to:
receive the game move instruction from the host;
output the game move instruction to the gaming controller; and
output a game operation instruction to the host.

7. The system of claim 3, wherein the gaming controller comprises a processing circuit, and the processing circuit is configured to receive the game move instruction and convert the game move instruction into a light control instruction for the indicator light.

8. The system of claim 5, wherein the gaming controller comprises a processing circuit, and the processing circuit is configured to receive the game move instruction and convert the game move instruction into a vibration instruction for the haptic feedback device.

9. The system of claim 1, wherein the game move instruction comprises a data frame in a preset size.

10. The system of claim 1, wherein a mapping is established between the game move instruction and a move sequence of the gaming controller.

11. The system of claim 10, wherein the mapping comprises at least one of: an action of the game move image corresponding to the first switch, a plurality of actions of the game move image corresponding to the first switch, an action of the game move image corresponding to the plurality of switches, and/or a plurality of actions of the game move image corresponding to the plurality of switches.

12. A method for training a game move, comprising:
receiving, from a host at a gaming controller, a game move instruction, wherein the gaming controller comprises a control panel, a plurality of switches arranged on the control panel, and a plurality of indicators corresponding to the plurality of switches, and the game move instruction is configured to control a first indicator and a first switch corresponding to the first indicator;
displaying, at a display, a game move image based on the game move instruction from the host, wherein the display is connected to the host; and
training, by the gaming controller, the game move based on the first indicator and the game move image.

13. The method of claim 12, wherein the host comprises a memory, and the memory is configured to store the game move instruction.

14. The method of claim 12, wherein the first indicator comprises an indicator light, and the indicator light indicates the first switch by a light of a predetermined color.

15. The method of claim 14, wherein the indicator light is arranged under the first switch or between the control panel and the first switch.

16. The method of claim 12, wherein the first indicator comprises a haptic feedback device, and the haptic feedback device indicates the first switch by vibration.

17. The method of claim 12, further comprising:
receiving, from the host by an input-and-output bus, the game move instruction;
outputting, from the input-and-output bus to the gaming controller, the game move instruction; and
outputting, from the input-and-output bus to the host, a game operation instruction.

18. The method of claim 14, further comprising:
receiving, by a processing circuit of the gaming controller, the game move instruction; and
converting, by the processing circuit of the gaming controller, the game move instruction into a light control instruction for the indicator light.

19. The method of claim 16, further comprising:
receiving, by a processing circuit of the gaming controller, the game move instruction; and
converting, by the processing circuit of the gaming controller, the game move instruction into a vibration instruction for the haptic feedback device.

20. The method of claim 12, wherein the game move instruction comprises a data frame in a preset size.
